(19) United States
(12) Patent Application Publication
(10) Pub. No.: US 2024/0149319 A1
(43) Pub. Date: May 9, 2024

(54) METHOD FOR PRODUCING AT LEAST ONE COMPONENT ELEMENT FOR A FURNITURE FITTING

(71) Applicant: Julius Blum GmbH, Hoechst (AT)

(72) Inventor: Olaf ISELE, Lustenau (AT)

(21) Appl. No.: 18/416,102

(22) Filed: Jan. 18, 2024

Related U.S. Application Data
(63) Continuation of application No. PCT/AT2022/060255, filed on Jul. 18, 2022.

(30) Foreign Application Priority Data
Jul. 23, 2021 (AT) A 50612/2021

(51) Int. Cl. B21C 37/04; A47B 88/40; B21D 17/02; B21D 28/24

(52) U.S. Cl. CPC B21C 37/045; A47B 88/40; B21D 17/02; B21D 28/24

(57) ABSTRACT

A method for producing a component element for a furniture fitting, in particular a rail, includes the following steps to be carried out in chronological order: providing a planar sheet having a longitudinal extension, two top surfaces and two side surfaces spaced apart by a width of the sheet, as a semifinished product of the component element. The sheet has a wall thickness in the range of 0.5 mm and 1.5 mm, and is formed, preferably by an embossing stamp and/or an embossing roller, on at least one top surface with an indentation. The indentation is arranged transversely, preferably substantially orthogonally, to the longitudinal extension. The sheet is bent such that, in a cross section orthogonal to the longitudinal extension, a profile of the component element arises, and the bent sheet is mechanically separated in the region of the indentation.

### BACKGROUND OF THE INVENTION

The invention relates to a method for producing at least one component part for a furniture fitting, in particular a rail, particularly preferably for a drawer pull-out guide. The invention also relates to a drawer pull-out guide for movably mounting a drawer on a furniture carcass.

The requirement for metal, which is necessary for the production of one of the rails or the like, represents a general problem in the manufacture of component parts such as rails, in particular for the furniture industry or furniture sector. High material usage leads to a high weight and to increased costs in series manufacturing. It is therefore desirable to use as little metal as possible, especially as a resource-conserving use of raw materials provides both environmental and economic advantages.

One measure for saving metal is the use of thin-walled metal sheets, wherein the weight of the rail can also be advantageously reduced. In the state of the art, rails, in particular for the furniture industry, are usually cut to length via a separating cut—for example using a sawblade of defined width—with the result that a rail with defined dimensions is generated. However, a large amount of metal is formed as waste product here, wherein there is a long-standing need in the furniture industry to bring about material savings by preventing such scrap metal.

A method for producing pipes and extruded profiles is already known from the document DE 10 2007 018 927 A1, wherein chamfers in the pipes or extruded profiles are utilized in order to minimize a risk of injury and a degree of deformation after a cutting-to-length process step, without generating separating scrap.

A disadvantage of the state of the art is that only semifinished products as such are utilized for the further transport of the semifinished products, but then the pipes and extruded profiles need to be adapted for the respective required field and the structural design of the semifinished products is determined by the primary forming process. There is, however, no method for a specific remit with defined tasks, individual purposes, structural designs as well as specific challenges.

Further methods are known from the documents US 2009/019804 A1, DE 19 641 144 A1, DE 10 2007 018 927 A1, U.S. Pat. No. 2,222,842 A as well as DE 2 030 561 A1.

### SUMMARY OF THE INVENTION

The objective technical problem of the present invention is therefore to specify a method for producing at least one component part for a furniture fitting that is improved compared with the state of the art and an improved drawer pull-out guide, in which the disadvantages of the state of the art are at least partially remedied, and which are characterized in particular by a reduction in metal waste during the production of component parts for a furniture fitting.

It is thus provided according to the invention that the following method steps are carried out in chronological order:
a flat, preferably metallic, particularly preferably steel, sheet with a longitudinal extent, two top surfaces and two lateral surfaces spaced apart by a width of the metal sheet is provided as a semifinished product of the at least one component part, preferably rail, wherein the metal sheet has a wall thickness in the range of 0.5 mm to 1.5 mm,
the metal sheet is provided, preferably by at least one embossing die and/or at least one embossing roller, on at least one top surface with at least one indentation, wherein the at least one indentation is arranged transverse, preferably substantially orthogonal, to the longitudinal extent,
the metal sheet is bent, with the result that, in a cross section orthogonal to the longitudinal extent, a profile of the at least one component part, preferably rail, is formed,
the bent metal sheet is mechanically separated, preferably snapped, particularly preferably cracked and split, in the region of the at least one indentation.

It is thereby made possible for the first time that material waste, which is formed in the furniture industry in the case of conventional component parts such as rails or the like due to the method for separating the rail from a profile material by cutting, can be effectively prevented. In mass production, this is associated with a reduced effort for disposing of and/or recycling scrap metal, with neater component parts and a cleaner machining environment, a lower postprocessing effort as well as a significant cost saving in production, since machining steps as well as punching waste or separating waste—caused, for example, by a cutting width of a separating tool—are accumulated with each component part manufactured.

Mechanical separation, such as breaking, cracking or splitting without the aid of cutting tools such as sawblades, was unknown until now in the field of the furniture industry and above all in the case of component parts such as rails, in particular because until now there has been the utmost effort to impair as little as possible the complex geometric designs of rails or the like—primarily due to large material thicknesses and a large cross-sectional diameter of the profiles with at the same time high demands for geometric accuracy and precision of the profile—by using the cutting separating methods, wherein according to the invention it is also guaranteed that the geometry of the profile of the at least one component part continues to be maintained precisely in cross section as well as over the longitudinal extent.

Particularly lightweight component parts with a small wall thickness can be manufactured particularly beneficially using the method with little effort and low plastic deformation, wherein the component part also has an esthetically appealing appearance to a large degree.

If the metal sheet (for example present as flat steel) is profiled via indentations before a bending procedure, complex geometries are also possible in the bending procedure for forming the at least one component part, wherein the at least one indentation follows the complex geometry of the profile of the at least one component part in order to be able to produce component parts particularly efficiently in series. The profile of the at least one component part is not undesirably impaired by the at least one indentation, in particular because it is introduced before the bending procedure.

By the technical term of mechanical separation is meant all separating methods which do not generate any material waste, for example caused by cutting separating methods.

The component part can represent, for example, a rail such as a carcass rail or a drawer rail, in particular for a drawer pull-out guide as furniture fitting, or a belt arm, an actuating arm, a hinge part, a housing part or the like for a flap fitting, or another furniture fitting such as a hinge.

There is also the positive property that, because of the lack of a burr—caused by a cutting separating method—the at least one component part represents a lower risk of injury to a user of a piece of furniture and/or an installer during the installation of the component part and no postprocessing is necessary. In addition, due to signs of wear and tear, separating tools for example have a limited service life, wherein maintenance and/or servicing work can be significantly reduced in the mass production of component parts. The longitudinal extension of the at least one component part can be flexibly adapted via the positioning of the at least one indentation, wherein the metal sheet need not already be present with the appropriate length dimensions in advance.

The at least one component part can, for example, represent a furniture rail, a carcass rail, a center rail, a drawer rail et cetera. Through work hardening in the separating-cut-free, non-cutting and preferably burr-free mechanical snapping-off procedure, the at least one indentation can act as a predetermined breaking point, wherein particularly beneficial material characteristics of the component part are obtained in a region around the at least one indentation.

The procedure for snapping off the component part can be effected using separating-cut-free separating tools, such as a ram or the like, or manually. Particularly preferably, a semiautomatic or automatic hydraulic or pneumatic drive is utilized in order to remove the at least one component part from a remaining material using pressure and/or tension (for example by pulling apart), wherein a punching tool, saw or grinding wheel (causing a burr and postprocessing steps) is not necessary. In the case of a bending load, the at least one indentation can act as a defined snapping edge for forming the at least one component part, wherein the tensile/compressive loads are focused on the at least one indentation.

The at least one indentation can be introduced into the metal sheet in strip form for example via an embossing die, such as a notch die, or an embossing roller, such as a notch roller, wherein, after the mechanical separation (snapping-off), a taper in the form of at least one chamfer is generally arranged on an end surface of the profile of the component part. The at least one indentation preferably comprises two flanks, wherein, after the snapping-off procedure, one flank is allocated to the at least one component part.

As stated at the beginning, protection is also sought for a drawer pull-out guide for movably mounting a drawer on a furniture carcass, comprising:
at least one carcass rail to be fastened to the furniture carcass and
at least one drawer rail, which is mounted displaceable relative to the at least one carcass rail in a longitudinal direction, to be connected to the drawer.

The at least one carcass rail and/or the at least one drawer rail, in a cross section orthogonal to the longitudinal direction, has a profile formed out of at least one flat metal sheet. The at least one carcass rail and/or the at least one drawer rail, as a component part, is produced using such a method, with the result that at least one, in particular two, end surface of the profile of the at least one carcass rail and/or of the at least one drawer rail is formed with a taper.

However, the use of the method is applicable to other furniture fittings apart from drawer pull-out guides.

The longitudinal direction is generally identical to the longitudinal extent of the metal sheet. Particularly preferably, the taper extends over the whole profile of the at least one component part in the end surface.

According to an advantageous design of the invention, the at least one indentation connects the two lateral surfaces of the metal sheet and/or at least two indentations lying opposite one another, preferably lying one above the other orthogonally in one direction on at least one of the two top surfaces, are arranged on the two top surfaces of the metal sheet.

A particularly symmetrical end surface of the component part can be generated using indentations lying one above the other, wherein indentations lying opposite one another and/or those arranged next to one another can generally have different depths and/or indentation geometries.

Advantageously, the bent metal sheet is mechanically separated, preferably snapped, particularly preferably cracked and split, at least at two, preferably at least two indentations lying one above the other.

However, it is generally also conceivable to use only one indentation for the mechanical separating procedure.

It has proved to be beneficial that the at least one component part is formed with a substantially burr-free taper on at least one, preferably two, end surfaces of the profile. Preferably, the taper has a taper cross section parallel to the longitudinal extent of the metal sheet substantially in the shape of a, preferably isosceles, triangle, and the taper cross section is particularly preferably formed convex and/or concave.

The taper is generally brought about by a combination of work hardening through the introduction of the at least one indentation and a plastic deformation in the mechanical separating method step and generally extends over the whole end surface of the profile.

According to an advantageous embodiment of the invention, the bent metal sheet, in the region of the at least one indentation, is broken without a separating cut, without punching and without cutting scrap. The at least one indentation is utilized as a predetermined breaking point while cracking the bent metal sheet, and preferably the at least one component part is formed without postprocessing.

The manner of the mechanical separation is generally as desired, wherein no cutting waste is formed during the mechanical separation and a cutting postprocessing can possibly be provided—but is not absolutely necessary—in order to be able to use the at least one component part directly as a furniture rail, for example.

It has proved to be advantageous that the metal sheet has a wall thickness in the range of 0.6 mm to 0.8 mm.

Through the wall thickness of less than 1.5 mm—which is used in conventional component parts such as rails—a particularly lightweight component part is provided, which can be mechanically separated in a particularly beneficial manner using the method according to the invention and has a low material consumption.

An advantageous variant of the present invention is that the metal sheet is folded in the region of at least one lateral surface to form a fold, preferably during the bending of the metal sheet.

Through a fold, a wall thickness can be doubled locally, in order to increase strength and/or stability properties at desired regions of the component part, without doubling the weight of the component part per se.

It is particularly preferred that the at least one indentation is introduced into the metal sheet in the shape of a groove or a profiling with an opening angle in the range between 40° and 140°, preferably between 75° and 105°, particularly preferably of substantially 90°.

For example, identical or different depths and/or geometries can be used for the at least one indentation, in order for it to act as a defined predetermined breaking point for the tearing off and/or snapping off.

In an embodiment of the invention, the at least one indentation has a notch cross section parallel to the longitudinal extent of the metal sheet in the shape of a triangle, a trapezoid, a segment of an ellipse and/or a segment of a circle.

After the bending procedure to form the profile of the metal sheet, the at least one indentation is particularly preferably present such that between 0.05 mm and 0.2 mm, preferably between 0.08 mm and 0.12 mm, remain between the two top surfaces. The at least one indentation particularly preferably comprises a trapezoidal shape, wherein the shortest side length of the trapezoid between the two top surfaces is between 0.1 mm and 0.4 mm, preferably between 0.15 mm and 0.25 mm.

According to a preferred embodiment of the invention, for each component part, in each case exactly four indentations, arranged in pairs on the two top surfaces, are introduced into the flat metal sheet. The component part is formed by snapping the bent metal sheet twice, preferably in succession, via the four indentations.

This can both benefit the mechanical separating procedure and maximize the material saving.

It has proved to be beneficial that the metal sheet is provided with a plurality of indentations arranged in pairs on the two top surfaces and then a plurality of component parts are mechanically snapped off.

A large quantity of component parts can thereby be produced time-efficiently in series and preferably without interruption via one and the same semifinished product.

Furthermore, preferably the taper includes an angle in the range between 60° and 140°, preferably between 75° and 105°, particularly preferably of substantially 90°. Preferably, at least one, preferably both, end surfaces are formed substantially burr-free.

The geometry of the taper can be flexibly adjusted via the geometry of the at least one indentation.

In a further embodiment, the at least one carcass rail and/or the at least one drawer rail has at least one fastening portion with a fastening side which, in the case of installation on the furniture carcass or at least one furniture part, can be brought to rest against the furniture carcass or the at least one furniture part at least in portions. The at least one fastening portion has at least one, preferably circular, opening for a fastening means, preferably a screw, to pass through. The at least one opening, on a second side spaced apart from the fastening side by a material thickness of the fastening portion, preferably of between 0.5 mm and 1.5 mm, particularly preferably between 0.6 mm and 0.8 mm, is surrounded by a ridge which protrudes transversely from the second side.

The peripheral rim of the opening is strengthened by the ridge, wherein the force emanating from the underside of a screwhead can be distributed over a larger surface area. The extent to which the screwhead sinks into the thin-walled metal of the fastening portion can be minimized by the ridge. The danger of damage to the peripheral rim of the opening can therefore be reduced in this way and material can be saved.

According to an advantageous design of the invention, the at least one carcass rail and/or the at least one drawer rail is folded in the region of at least one profile surface of the profile to form a fold.

Through the fold, a ratio of load-bearing capacity of the rail or another component part to the weight of the rail/component part can be increased.

Particularly preferably, the at least one taper has a taper cross section parallel to the longitudinal extent of the metal sheet substantially in the shape of a, preferably isosceles, triangle. Preferably, the taper cross section is formed convex and/or concave.

According to a preferred embodiment, the profile has at least one embossing, preferably oriented orthogonally on the longitudinal extent of the metal sheet, for reinforcing the profile. Preferably, the at least one embossing extends over at least two substantially orthogonal profile surfaces, and/or at least two embossings are provided which are alternately arranged toward an inner region and toward an outer region of the profile.

The at least one embossing benefits the stability and/or strength of the at least one component part with a particularly efficient material requirement.

### BRIEF DESCRIPTION OF THE DRAWINGS

Further details and advantages of the present invention are explained in more detail below via the description of the figures, in which:

FIGS. 1a-1b show a drawer pull-out guide according to a particularly preferred embodiment with and without a carriage in a view from the front,

FIGS. 2a-2b show a drawer pull-out guide with a carcass rail and a drawer rail as component part of a furniture fitting according to the embodiment according to FIG. 1a and an enlarged detail section of the drawer rail in a perspective view,

FIGS. 3a-3c show a rail during the method for producing the rail with indentations in the profiled state, in a bent and an unbent state, as well as a detail section of the indentations in an enlarged detail section, in a perspective view and a view from the side,

FIGS. 4a-4b show a rail according to the embodiment according to FIG. 3a in a perspective view and the rail, after a semifinished product has been separated off, in a perspective view and a view from the side,

FIG. 5 shows the rail according to the embodiment according to FIG. 4b in a perspective view, a view from the side and a detail section of the snapping-off point between rail and semifinished product,

FIG. 6 shows the rail according to the embodiment according to FIG. 3a during the mechanical separating method step in a perspective view, a view from the side and an enlarged detail section of the separation region of the rail and the semifinished product, and

FIG. 7 shows the rail according to the embodiment according to FIG. 4b after the rail has been separated from the semifinished product in a perspective view, a view from the side as well as an enlarged detail section of the end surfaces in each case with a taper on the semifinished product and on the rail.

### DETAILED DESCRIPTION OF THE INVENTION

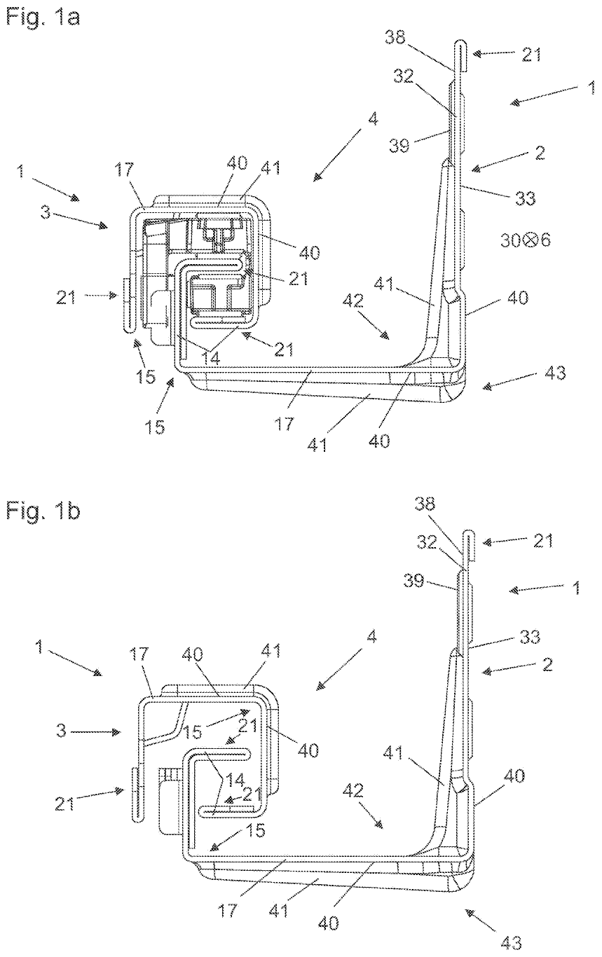

FIG. 1 shows a drawer pull-out guide 4 for movably mounting a drawer on a furniture carcass (in the representations, furniture parts are not represented for reasons of clarity), comprising a carcass rail 2 to be fastened to the furniture carcass and a drawer rail 3, which is mounted displaceable relative to the carcass rail 2 in a longitudinal direction 30, to be connected to the drawer. The carcass rail 2 and the drawer rail 3 each represent a rail as component part 1 for a furniture fitting, which is present in the form of a drawer pull-out guide 4 in this embodiment.

A carriage for guiding the drawer rail 3 relative to the carcass rail 2 is arranged between the carcass rail 2 and the drawer rail 3. In addition, a center rail can generally be provided, which is arranged on the carcass rail 2 and/or the drawer rail 3.

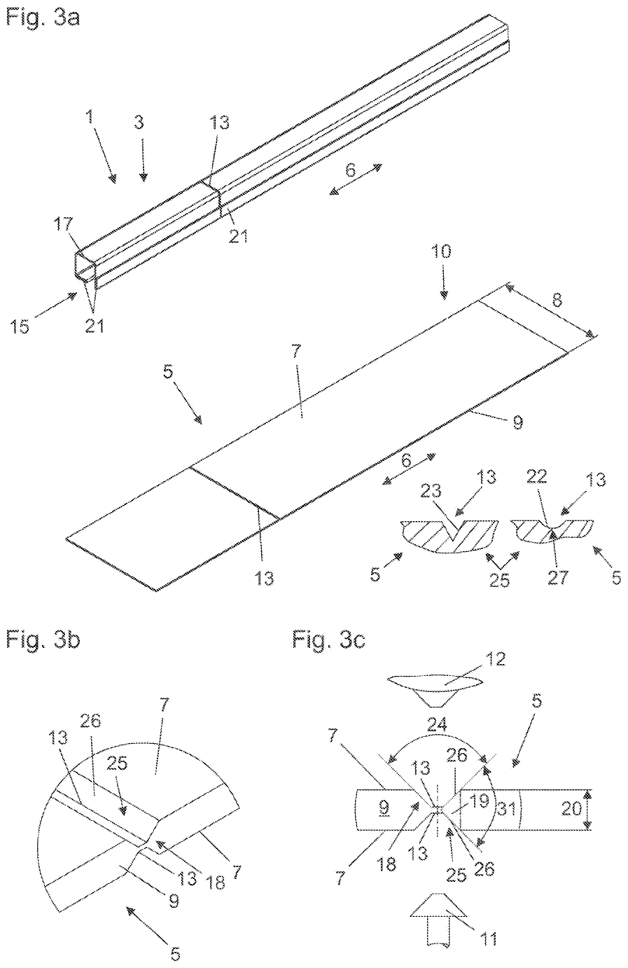

The carcass rail 2 and the drawer rail 3, in a cross section 14 orthogonal to the longitudinal direction 30, have a profile 15 formed out of a flat metal sheet 5, wherein the carcass rail 2 and the drawer rail 3 are produced using a method for producing a rail 1 for the drawer pull-out guide 4, which is explained in more detail according to FIG. 3a to FIG. 7c.

FIG. 1b differs from FIG. 1a only in that the carriage has been removed for representational purposes. A punching out of the drawer rail 3 is thereby visible, which is connected in a material-bonding manner to two orthogonal profile surfaces 40 and serves both as reinforcement and as limit stop for the carriage.

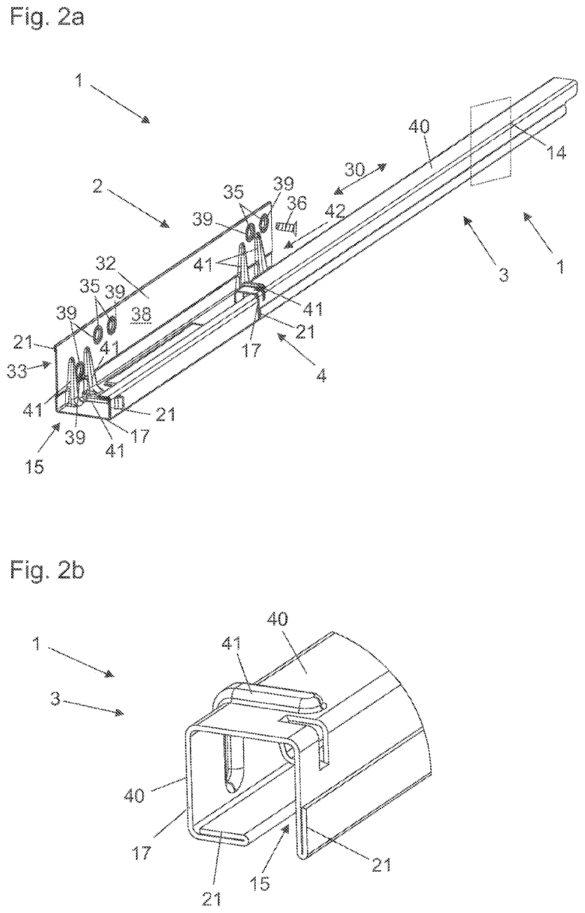

FIG. 2a shows the arrangement of a drawer rail 3 and a carcass rail 2 in a partially extended position. The profile 15 of the carcass rail 2 comprises six embossings 41, oriented orthogonally on a longitudinal extent 6 of the metal sheet 5, for reinforcing the profile 15, wherein two groups in each case of three embossings 41 are provided, which are alternately arranged toward an inner region 42 and toward an outer region 43 of the profile 15. However, only one group and/or groups of two or more alternating embossings 41 is generally also possible.

The carcass rail 2 and the drawer rail 3 are each folded in the region of two profile surfaces 40 of the profile 15 to form a fold 21. In general, only one rail 1 can also have folds 21 and/or comprise only one or more fold(s) 21. The folds 21 can be generated before, after and/or preferably during a procedure for bending the profile 15.

The carcass rail 2 comprises a fastening portion 32 with a fastening side 33 which, in the case of installation on the furniture carcass, can be brought to rest against the furniture carcass or the at least one furniture part. The fastening portion 32 comprises four circular openings for a fastening means 36 in the form of a screw to pass through. On a second side 38 spaced apart from the fastening side 33 by a material thickness of the fastening portion 32—which can generally deviate compared with the wall thickness 20 of the metal sheet—the openings 35 are surrounded by a ridge 39, which protrudes transversely from the second side 38.

The profile 15 is particularly effectively prevented from gaping (enlargement of an angle between lateral surfaces 9) by a punching in the end region of the carcass rail 2 which protrudes through the fold 21, wherein the embossings 41 of the carcass rail 2 and of the drawer rail 3 also counteract the gaping of the rails by increasing a moment of resistance of the profile 15 or a stability/strength of the profile and inhibit a deformation of the profile 15—in particular in the longitudinal direction 30.

Two punchings are generally provided on both end regions of the carcass rail 2, which can be utilized for connecting the carcass rail 2 to a furniture part, wherein one punching is particularly preferably oriented orthogonally on the lateral surface 9 and a further punching is arranged parallel to the lateral surface 9 due to a bend.

FIG. 2b shows an enlarged detail section of the drawer rail 3 of the drawer pull-out guide 4. The profile 15 of the drawer rail 3 comprises an embossing 41, which extends across two orthogonal profile surfaces 40.

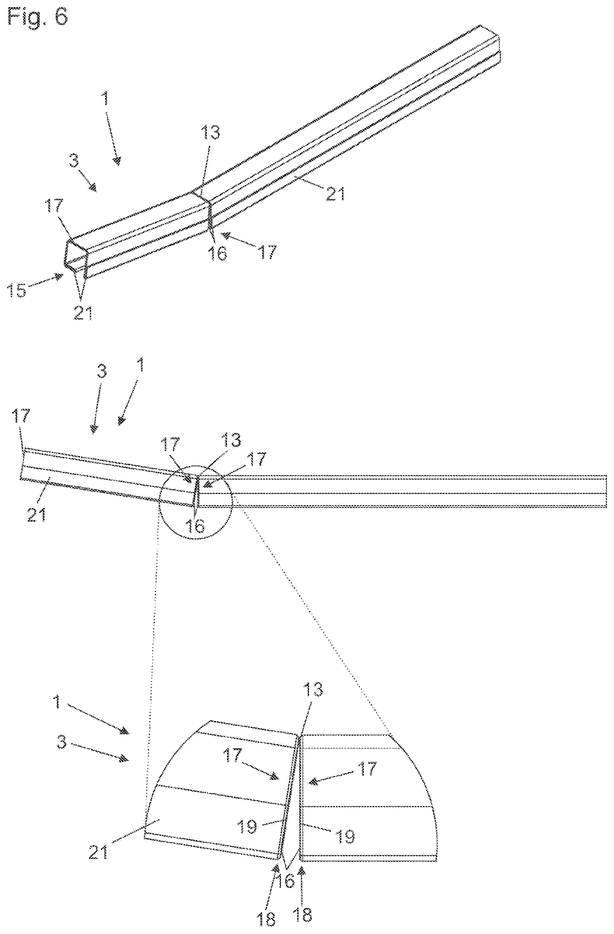

In general, at least one end surface 17, and preferably both end surfaces 17, of the profile 15 of the drawer rail 3 and of the carcass rail 2 (see FIG. 2a) is formed with a taper 16 (cf. FIG. 6); these are not visible in the representation for reasons of clarity.

FIG. 3a explains the method for producing a rail 1, wherein
a flat metallic sheet 5 with a longitudinal extent 6, two top surfaces 7 and two lateral surfaces 9 spaced apart by a width 8 of the metal sheet 5 is provided as a semifinished product 10 of the rail 1,
in this embodiment, the metal sheet 5 is provided with an indentation 13 on both top surfaces 7, wherein the indentations 13 are arranged orthogonal to the longitudinal extent 6,
the metal sheet 5 is bent, with the result that, in a cross section 14 orthogonal to the longitudinal extent 6, the profile 15 of the rail 1 is formed and
the bent metal sheet 5 is mechanically separated in the region of the indentations 13, wherein the rail 1 can be snapped off the remaining material—which can be used for manufacturing further rails 1—mechanically by cracking to form the split.

The metallic sheet 5 is formed of steel. However, aluminum or the like can generally also be used for example. It is also conceivable only to introduce one indentation 13 into the metal sheet 5 and/or to arrange the indentation 13 at an angle relative to the longitudinal extent 6 that is not equal to 90° in order to form the rail in a non-cutting manner without cutting scrap.

In the sectional representation, two possible geometric designs of the indentation 13 are visible, wherein one indentation 13 has been introduced into the metal sheet 5 in the shape of a groove 22 with a notch cross section 25 parallel to the longitudinal extent 6 in the shape of a segment of an ellipse 27 and one indentation 13 has been introduced into the metal sheet 5 in the shape of a profiling 23 with a triangular 19 notch cross section 25 with an opening angle 24 of 60°.

The metal sheet 5 has a wall thickness 20 of 0.7 mm.

FIG. 3b shows an enlarged detail section of the metal sheet 5 with the preferred geometry of the indentation 13, wherein the indentation 13 has a notch cross section 25 parallel to the longitudinal extent 6 of the metal sheet 5 in the shape of a trapezoid 26. The two indentations 13 connect the two lateral surfaces 9 of the metal sheet 5 and are arranged opposite one another on the two top surfaces 7 of the metal sheet 5 and lying one above the other orthogonally in one direction on at least one of the two top surfaces 7.

FIG. 3c shows the two indentations 13 from the side, wherein generally, for each rail 1, in each case exactly four indentations 13, arranged in pairs on the two top surfaces 7, are introduced into the flat metal sheet 5, in order to form the rail 1 by snapping the bent metal sheet 5 twice in succession via the four indentations 13. The metal sheet 5 can be provided with a plurality of indentations 13 arranged in pairs on the two top surfaces 7, with the result that a plurality of rails 1 can then be mechanically snapped off.

In this embodiment, the introduction of the indentations 13 is effected via an embossing die 11 and an embossing roller 12, wherein generally only one embossing roller 12 or embossing die 11 or (preferably) two embossing rollers 12 or embossing dies 11 can be provided, in order to introduce the indentations 13 into the metal sheet 5 before a bending and/or folding procedure.

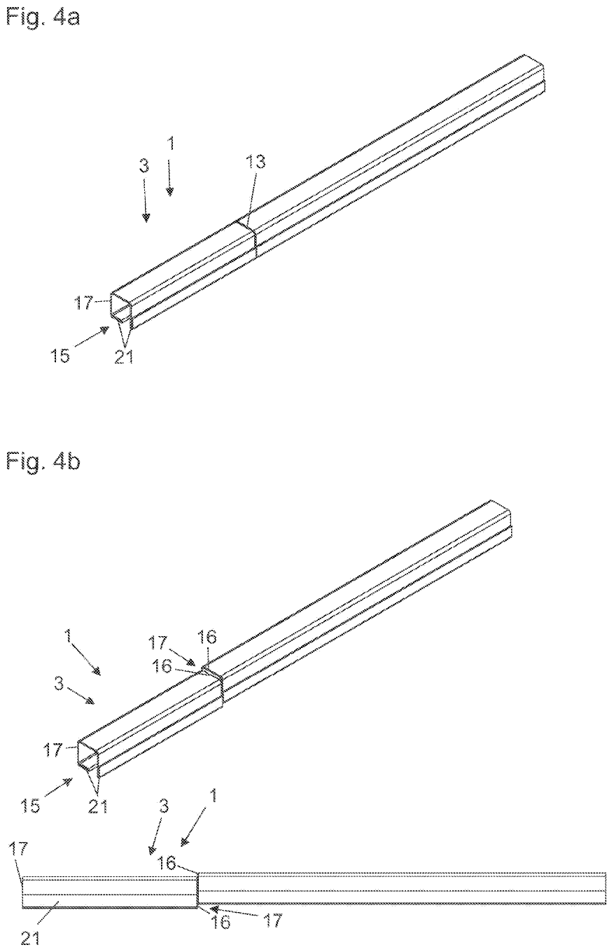

FIG. 4a shows the rail 1, which is provided as a drawer rail 3, in perspective view before a process step for separating from the rest of the profile material. In an analogous manner, a rail 1 formed as a carcass rail 2 can be provided.

FIG. 4b shows that the bent metal sheet 5 has been mechanically separated at the two indentations 13 lying one above the other by snapping via cracking and splitting. The rail 1 has thereby been formed with a burr-free taper 16 at one end surface 17 of the profile 15, wherein the second end surface 17 has generally also been generated in this way. The remaining profile material already has the taper 16, which can be utilized for a following rail 1 without postprocessing, wherein a cutting postprocessing step such as filing or grinding can generally be provided, in order to adapt the shape of the taper 16 or possibly to remove undesired bumps.

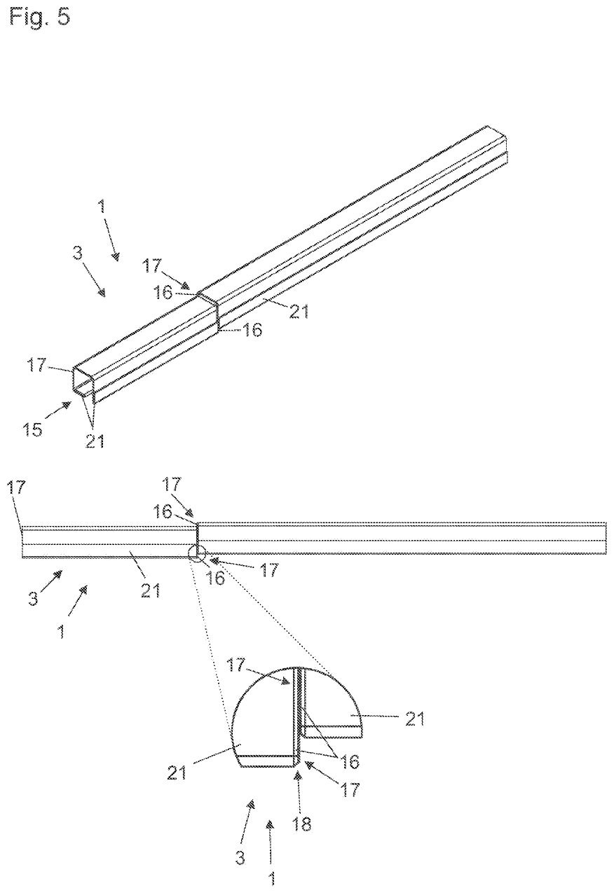

FIG. 5 shows the rail 1 after it has been snapped off via the indentations 13, wherein the taper 16 has a taper cross section 18 parallel to the longitudinal extent 6 of the metal sheet 5 in the shape of an isosceles triangle 19. In general, due to the non-cutting separating process, via plastic deformation, a ridge-shaped end portion can remain at the taper 16 or the taper cross section 18 can be formed convex or concave. However, a material-removing process step with material waste is not necessary for the separating procedure.

FIG. 6 shows the rail 1 during the snapping off via two indentations 13, wherein the bent metal sheet 5, in the region of the indentations 13, is broken without a separating cut, without punching and without cutting scrap, wherein the indentations 13 are utilized as a predetermined breaking point while cracking the bent metal sheet 5. However, pulling the rail 1 away from the remaining profile material is also conceivable. The rail 1 is formed without postprocessing; however, postprocessing steps can definitely still be performed on the rail 1, depending on requirements.

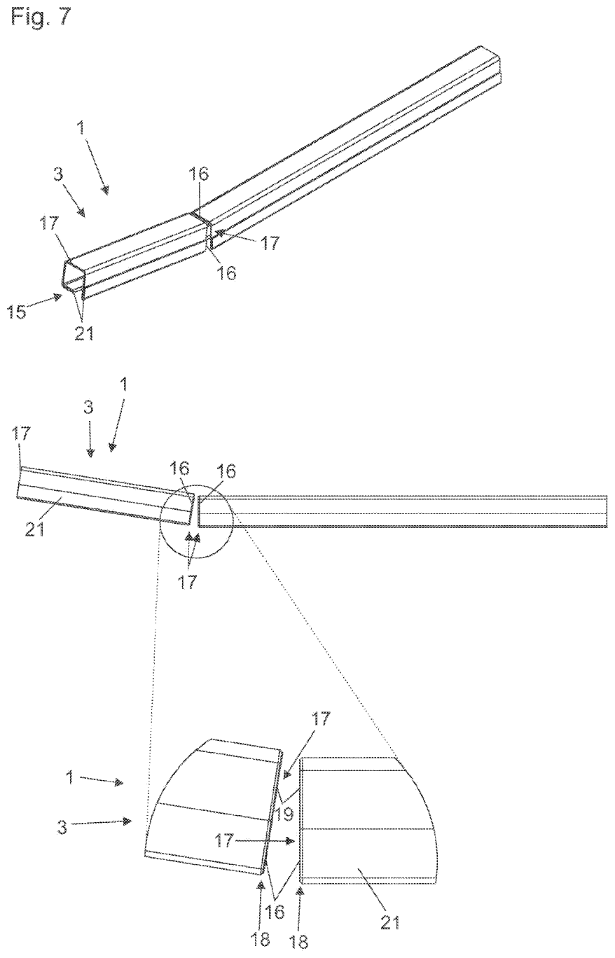

FIG. 7 shows the rail 1 after it has been snapped off via the indentations 13, wherein the taper 16 of the rail 1 has an angle 31 (cf. FIG. 3c) of 90° in the viewing direction orthogonally on the longitudinal extent 6, wherein the end surfaces 17 are formed burr-free. If only one indentation 13 is used for the snapping-off procedure, an angle 31 of 45° can, for example, also be utilized, wherein the taper 16 can be formed as a right-angled triangle 19 as distinct from an isosceles triangle 19.

1. A method for producing at least one component part (1) for a furniture fitting, in particular a rail, particularly preferably for a drawer pull-out guide, comprising the following method steps to be carried out in chronological order:
a flat, preferably metallic, particularly preferably steel, sheet with a longitudinal extent, two top surfaces and two lateral surfaces spaced apart by a width of the metal sheet is provided as a semifinished product of the at least one component part, preferably rail, wherein the metal sheet has a wall thickness in the range of 0.5 mm to 1.5 mm,
the metal sheet is provided, preferably by at least one embossing die and/or at least one embossing roller, on at least one top surface with at least one indentation, wherein the at least one indentation is arranged transverse, preferably substantially orthogonal, to the longitudinal extent,
the metal sheet is bent, with the result that, in a cross section orthogonal to the longitudinal extent, a profile of the at least one component part, preferably rail, is formed,
the bent metal sheet is mechanically separated, preferably snapped, particularly preferably cracked and split, in the region of the at least one indentation.

2. The method according to claim 1, wherein the at least one indentation connects the two lateral surfaces of the metal sheet and/or at least two indentations lying opposite one another, preferably lying one above the other orthogonally in one direction on at least one of the two top surfaces, are arranged on the two top surfaces of the metal sheet.

3. The method according to claim 1, wherein the bent metal sheet is mechanically separated, preferably snapped, particularly preferably cracked and split, at least at two, preferably at least two indentations lying one above the other.

4. The method according to claim 1, wherein the at least one component part is formed with a substantially burr-free taper on at least one, preferably two, end surfaces of the profile, wherein it is preferably provided that the taper has a taper cross section parallel to the longitudinal extent of the metal sheet substantially in the shape of a, preferably isosceles, triangle, wherein the taper cross section is particularly preferably formed convex and/or concave.

5. The method according to claim 1, wherein the bent metal sheet, in the region of the at least one indentation, is broken without a separating cut, without punching and without cutting scrap, wherein the at least one indentation is utilized as a predetermined breaking point while cracking the bent metal sheet, wherein it is preferably provided that the at least one component part is formed without postprocessing.

6. The method according to claim 1, wherein the metal sheet has a wall thickness in the range of 0.6 mm to 0.8 mm.

7. The method according to claim 1, wherein the metal sheet is folded in the region of at least one lateral surface to form a fold, preferably during the bending of the metal sheet.

8. The method according to claim 1, wherein the at least one indentation is introduced into the metal sheet in the shape of a groove or a profiling with an opening angle in the range between 40° and 140°, preferably between 75° and 105°, particularly preferably of substantially 90°.

9. The method according to claim 1, wherein the at least one indentation has a notch cross section parallel to the longitudinal extent of the metal sheet in the shape of a triangle, a trapezoid, a segment of an ellipse and/or a segment of a circle.

10. The method according to claim 1, wherein, for each component part, in each case exactly four indentations, arranged in pairs on the two top surfaces, are introduced into the flat metal sheet, wherein the component part is formed by snapping the bent metal sheet twice, preferably in succession, via the four indentations.

11. The method according to claim 1, wherein the metal sheet is provided with a plurality of indentations arranged in pairs on the two top surfaces and then a plurality of component parts are mechanically snapped off.

12. A drawer pull-out guide for movably mounting a drawer on a furniture carcass, comprising
at least one carcass rail to be fastened to the furniture carcass and
at least one drawer rail, which is mounted displaceable relative to the at least one carcass rail in a longitudinal direction, to be connected to the drawer,
wherein the at least one carcass rail and/or the at least one drawer rail, in a cross section orthogonal to the longitudinal direction, has a profile formed out of at least one flat metal sheet, wherein the at least one carcass rail and/or the at least one drawer rail, as component part, is produced using a method according to claim 1, with the result that at least one, in particular two, end surfaces of the profile of the at least one carcass rail and/or of the at least one drawer rail is formed with a taper.

13. The drawer pull-out guide according to claim 12, wherein the taper includes an angle in the range between 60° and 140°, preferably between 75° and 105°, particularly preferably of substantially 90°, wherein it is preferably provided that at least one, preferably both, end surfaces are formed substantially burr-free.

14. The drawer pull-out guide according to claim 12, wherein the at least one carcass rail and/or the at least one drawer rail has at least one fastening portion with a fastening side which, in the case of installation on the furniture carcass or at least one furniture part, can be brought to rest against the furniture carcass or the at least one furniture part at least in portions, wherein the at least one fastening portion has at least one, preferably circular, opening for a fastening means, preferably a screw, to pass through, wherein the at least one opening, on a second side spaced apart from the fastening side by a material thickness of the fastening portion, preferably of between 0.5 mm and 1.5 mm, particularly preferably between 0.6 mm and 0.8 mm, is surrounded by a ridge which protrudes transversely from the second side.

15. The drawer pull-out guide according to claim 12, wherein the at least one carcass rail and/or the at least one drawer rail is folded in the region of at least one profile surface of the profile to form a fold.

16. The drawer pull-out guide according to claim 12, wherein the at least one taper has a taper cross section parallel to the longitudinal extent of the metal sheet substantially in the shape of a, preferably isosceles, triangle, wherein it is preferably provided that the taper cross section is formed convex and/or concave.

17. The drawer pull-out guide according to claim 12, wherein the profile has at least one embossing, preferably oriented orthogonally on the longitudinal extent of the metal sheet, for reinforcing the profile, wherein it is preferably provided that the at least one embossing extends over at least two substantially orthogonal profile surfaces and/or at least two embossings are provided which are alternately arranged toward an inner region and toward an outer region of the profile.
